(19) United States
(12) Patent Application Publication
(10) Pub. No.: US 2015/0075838 A1
(43) Pub. Date: Mar. 19, 2015

(54) CABLES FOR A CABLE BUNDLE

(71) Applicant: Tyco Electronics Corporation, Berwyn, PA (US)

(72) Inventors: Arthur G. Buck, Sherwood, OR (US); James William Huffaker, Wilsonville, OR (US); Yevgeniy Mayevskiy, Lake Oswego, OR (US)

(73) Assignee: Tyco Electronics Corporation, Berwyn, PA (US)

(21) Appl. No.: 14/031,808

(22) Filed: Sep. 19, 2013

(51) Int. Cl. H01B 11/06; H01B 7/282; H01B 7/30

(52) U.S. Cl. CPC H01B 11/06; H01B 7/303; H01B 7/2825
USPC 174/103

(57) ABSTRACT

A cable bundle includes a bundle jacket having a central core and a plurality of cables received in the central core and surrounded by the bundle jacket. Each cable includes a twisted pair of insulated conductors, a dedicated inner shield surrounding the corresponding twisted pair of insulated conductors, a dedicated outer braid surrounding the corresponding inner shield and being electrically coupled to the corresponding inner shield, and a dedicated jacket surrounding the corresponding outer braid.

### BACKGROUND OF THE INVENTION

The subject matter herein relates generally to cables having differential twisted pairs.

Data cables are typically bundled together as a cable bundle and used in many applications, including data communication applications, medical applications, and others. Some known data cables include pairs of insulated conductors that are twisted together, sometimes referred to as “twisted pairs.” As operating frequencies of data cables increase, improved performance of the twisted pairs becomes more important. For example, data cables must meet electrical performance characteristics required for transmission at frequencies above a predetermined threshold.

Various cable designs have been used to attempt to improve signal quality and meet industry standards. For example, some known data cables use a shield around the twisted pairs to provide electrical shielding and improve signal quality. Different types of shields are known; however such shields have known problems. For example, some shields use a conductive braid to provide the shielding. The conductive braids are durable and flexible; however such conductive braids do not electrically perform as well as other shield types, particularly in higher frequencies, such as in the GHz range. Some shields use a metal film or tape wrapped around the twisted pair; however such films are fragile and break or tear when mechanically stressed, such as when the cable is bent. Additionally, such shields are susceptible to mechanical degradation, such as from moisture or chemical exposure even within the outer jacket of the cable bundle.

Achieving high speed digital signal performance requires consistency in the physical elements of the cable, such as the conductors and shield, throughout the length of the transmission line. When data cables are used in some applications, such as medical applications that require multiple sterilization processes and/or tortuous manipulation of the cable, the properties of the physical elements may be compromised over time. For example, data cables used with camera based medical endoscopes for internal imaging of a patient's body during surgical procedures require high data speeds to transmit the video images. Such cables are also subjected to chemical sterilization processes after use. A need remains for a cable that supports high data rates and that is capable of undergoing high temperature sterilization processes.

### BRIEF SUMMARY OF THE INVENTION

In one embodiment, a cable bundle is provided including a bundle jacket having a central core and a plurality of cables received in the central core and surrounded by the bundle jacket. Each cable includes a twisted pair of insulated conductors, a dedicated inner shield surrounding the corresponding twisted pair of insulated conductors, a dedicated outer braid surrounding the corresponding inner shield and being electrically coupled to the corresponding inner shield, and a dedicated jacket surrounding the corresponding outer braid.

Optionally, the inner shield and outer braid may cooperate to provide a continuous shield along the entire length of the cable. The inner shield may be segmented into a plurality of shield segments. The outer braid may electrically connect the shield segments along the length of the cable. The outer braid may include a plurality of conductive strands each being electrically connected to at least two shield segments of the inner shield.

Optionally, the inner shield may be manufactured from a material having better electrical shielding characteristic than the outer braid and the outer braid may be manufactured from a material having better flexibility characteristics than the inner shield.

Optionally, the inner shield may be a film having an insulating layer and a metal layer. The metal layer may face the outer braid and the outer braid may be electrically connected to the metal layer. The film may be a polyester (e.g. Mylar) film. The metal layer may be a copper layer.

Optionally, the cable jacket may provide a moisture barrier for the corresponding outer braid, inner shield and twisted pair of insulated conductors. The cable jacket may be a fluorocarbon material. The outer braid of each cable within the central core may be separated from other outer braids by the cable jackets of the corresponding cables.

In another embodiment, a cable bundle is provided that includes a bundle jacket having a central core and a plurality of cables received in the central core and surrounded by the bundle jacket. Each cable may include a twisted pair of insulated conductors, a dedicated inner shield, a dedicated outer shield, and a dedicated cable jacket. The inner shield includes a film having an insulating layer and a metal layer. The inner shield surrounds the corresponding twisted pair of insulated conductors with the metal layer facing away from the twisted pair of insulated conductors. The outer shield includes a conductive braid surrounding the corresponding inner shield that is electrically coupled to the corresponding inner shield at a plurality of locations along a length of the conductive braid. The cable jacket surrounds the corresponding outer braid. The cable jacket includes a hydrophobic material defining a moisture barrier for the corresponding outer shield, inner shield and twisted pair of insulated conductors.

In a further embodiment, a cable bundle is provided that includes a bundle jacket having a central core, a bundle shield in the central core that is metal and defines an electrical shield for the central core, a drain wire in the central core that is electrically connected to the bundle shield, and a plurality of cables received in the central core and surrounded by the bundle jacket and bundle shield. Each cable includes a twisted pair of insulated conductors, a dedicated inner shield surrounding the corresponding twisted pair of insulated conductors, a dedicated outer braid surrounding the corresponding inner shield and being electrically coupled to the corresponding inner shield, and a dedicated jacket surrounding the corresponding outer braid.

### BRIEF DESCRIPTION OF THE DRAWINGS

FIG. 1 is a cross sectional view of a portion of an exemplary embodiment of a cable bundle.

FIG. 2 is a perspective view of the cable bundle.

FIG. 3 is a cross sectional view of a cable of the cable bundle.

### DETAILED DESCRIPTION OF SPECIFIC EMBODIMENTS OF THE INVENTION

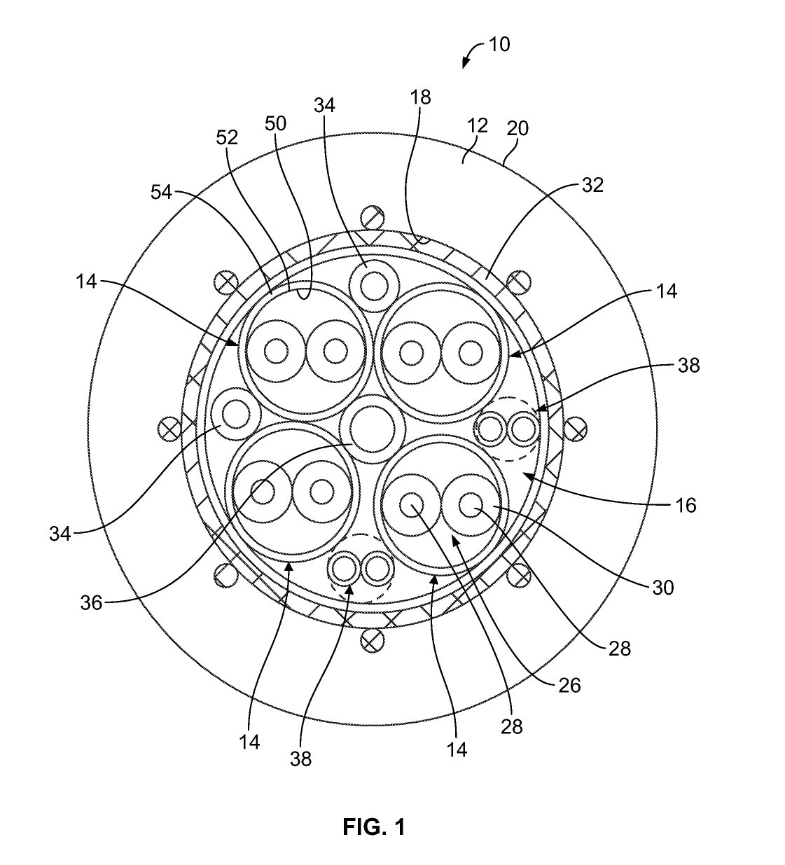

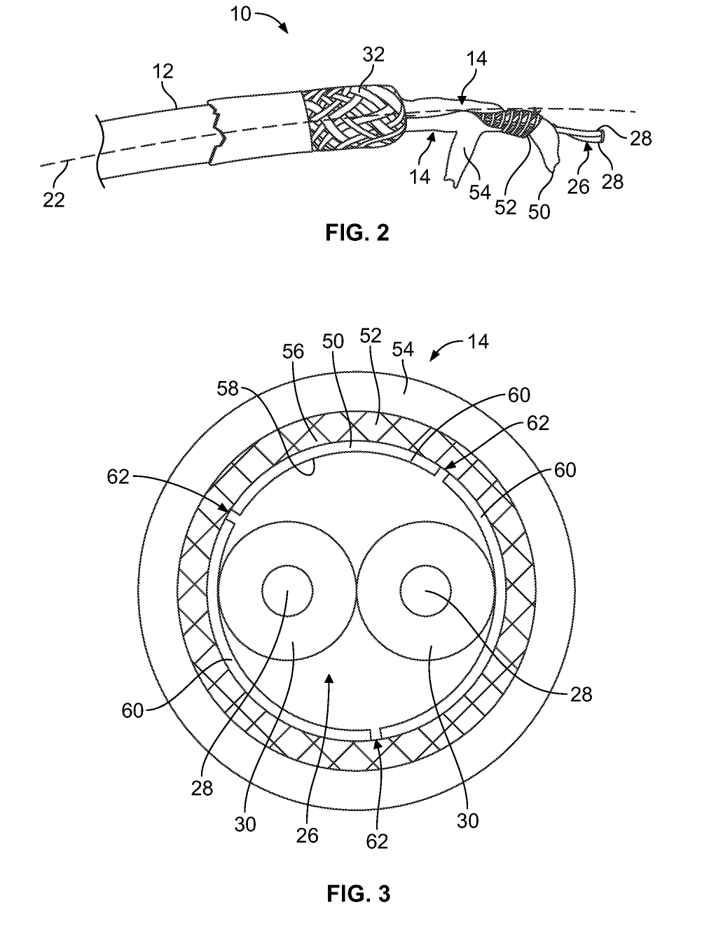

FIG. 1 is a cross sectional view of a portion of an exemplary embodiment of a cable bundle 10. FIG. 2 is a perspective view of the cable bundle 10. In the description that follows, the cable bundle 10 will be described and/or illustrated in terms of high-speed cabling, such as, but not limited to, a data communication cable for use in high resolution video imaging. The cable bundle 10 may be used in medical applications, such as camera based medical endoscopes used for internal imaging of the body during minimally invasive surgical procedures. The cable bundle 10 may be particularly adapted for repeated high temperature and/or low temperature chemical sterilization as the cable bundle 10 may be used in surgical applications. However, it is to be understood that the benefits described and/or illustrated herein are also applicable to other types of cables, including, but not limited to, wires, cords, cables, and/or the like of any type. The following description and illustrations are therefore provided for illustrative purposes only and are but one potential application of the subject matter described and/or illustrated herein.

The cable bundle 10 includes an insulative bundle jacket 12 and a plurality of cables 14 positioned within the bundle jacket 12. The bundle jacket 12 surrounds the cables 14. Specifically, the bundle jacket 12 includes a passageway or central core 16 within which the cables 14 extend. The cables 14 extend within the central core 16 along the length of the cable bundle 10. The bundle jacket 12 is fabricated from any insulative, non-conductive materials, such as, but not limited to, a polymer such as polyvinyl chloride (PVC), polypropylene, a fluoropolymer, polyethylene, and/or the like. Optionally, the bundle jacket 12 may be fabricated from a hydrophobic material and the bundle jacket 12 may be water resistant or water proof. In the exemplary embodiment, the bundle jacket 12 includes an approximately smooth inner surface 18 and an approximately smooth outer surface 20. The cable bundle 10 and the bundle jacket 12 extend along a central longitudinal axis 22 that extends along the length of the cable bundle 10.

In an exemplary embodiment, each of the cables 14 includes a plurality of twisted pairs 26 of insulated conductors 28 arranged in the central core 16. In the illustrated embodiment, four twisted pairs 26 of insulated conductors 28 are provided, however any number of twisted pairs 26 of insulated conductors 28 may be provided. The twisted pairs 26 may each be referred to herein as a “first”, a “second”, a “third”, and/or a “fourth” twisted pair. In an exemplary embodiment, each of the conductors 28 is at least partially surrounded by an insulative layer 30. The conductors 28 may be fabricated from any conductive materials, such as, but not limited to, copper and/or the like. The insulative layers 30 are fabricated from any insulative, non-conductive materials, such as, but not limited to, a polymer such as PVC, polypropylene, a fluoropolymer, polyethylene, and/or the like.

In an exemplary embodiment, the twisted pairs 26 are independently sealed and electrically shielded. The sealing provides protection from the environment in the central core 16, such as moisture protection. For example, each twisted pair may have a moisture barrier to protect the conductors 28 from water or chemicals in the central core 16. The sealing may ensure that the cable maintains mechanical and electrical integrity during use in harsh environments, after cleaning or sterilization, and the like. The electrical shielding provides low differential signal attenuation, which enhances the electrical performance of the cable 14, such as for high speed applications. Optionally, the electrical shielding is flexible and maintains mechanical and electrical integrity with use and manipulation.

In an exemplary embodiment, the cable bundle 10 includes a bundle shield 32 in the central core 16. The bundle shield 32 is arranged along the inner surface 18 of the bundle jacket 12. The bundle shield 32 provides electrical shielding for the cables 14. The bundle shield 32 may be fabricated from any conductive materials, such as, but not limited to, a braid of conductive strands, fibers, and/or the like, a laminated metal tape, an aluminum polyimide laminated tape, an aluminum biaxially-oriented polyethylene terephthalate (BoPEt) laminated tape, a tube formed from a continuous (e.g., a sheet) conductive material, and/or the like. The bundle shield 32 is optionally connected to a ground or other source of electrical energy to provide active shielding. The bundle shield 32 extends around the central core 16 and the cables 14.

Optionally, one or more filler elements 34 is positioned within the central core 16 of the bundle jacket 12, for example to facilitate holding the cables 14 in proper positions within the cable bundle 10 to facilitate providing the cable bundle 10 with a predetermined shape (e.g., cylindrical), and/or the like. Each of the filler elements 34 may be fabricated from one or more dielectric materials such that the filler element 34 is at least partially insulative and non-conductive. Optionally, the cable bundle 10 includes one or more drain wires 36 positioned within the central core 16 of the bundle jacket 12 between and/or along the cables 14. The drain wires 36 may be electrically commoned with the bundle shield 32. The drain wires 36 may provide electrical shielding between and/or along the cables 14. The drain wires 36 may provide a source of ground or other electrical energy for the cables 14. Optionally, the cable bundle 10 may include one or more low speed wires 38. The low speed wires 38 may be insulated conductors. The low speed wires may be arranged in pairs and may carry differential signals. The cables 14, filler elements 34, drain wires 36 and/or low speed wires 38 may be loaded into the central core 16 of the bundle jacket 12 during a cabling operation.

FIG. 3 is a cross sectional view of one of the cables 14. The cable 14 includes the twisted pair 26 of insulated conductors 28, which is independently sealed and electrically shielded. The cable 14 includes a dedicated inner shield 50, a dedicated outer shield 52 and a dedicated cable jacket 54.

The inner shield 50 surrounds the corresponding twisted pair 26 of insulated conductors 28. In an exemplary embodiment, the inner shield 50 is a film having a metal layer 56 and an insulating layer 58. The metal layer(s) 56 may be located on a radially outer side of the inner shield 50 (e.g., facing radially toward the outer shield 52). The insulating layer 58 may be a biaxially-oriented polyethylene terephthalate (BoPEt) layer; however the insulating layer 58 may be made from other materials in alternative embodiments. The metal layer 56 may be a copper layer applied to the insulating layer 58, such as by plating, laminating, adhering or other processes. The metal layer 56 may be other metals in alternative embodiments, such as silver, aluminum, and the like, however copper tapes provides high temperature resistance and better flex life than aluminum tapes as copper flexes better than aluminum and can be applied thinner. The inner shield 50 may be other materials in alternative embodiments, such as, but not limited to, a metal laminated polyimide tape, a braid of conductive strands, fibers, and/or the like, a tube formed from a continuous (e.g., a sheet) conductive material, and/or the like. In an exemplary embodiment, the inner shield 50 is highly conductive and has high coverage for good electrical shielding around the twisted pair 26 of insulated conductors 28.

The outer shield 52 surrounds the corresponding inner shield 50 and is electrically coupled to the inner shield 50. In an exemplary embodiment, the outer shield 52 is a braid of conductive strands or fibers. The outer shield 52 may be referred to hereinafter as an outer braid 52. The outer braid 52 may be a silver plated copper braid. The outer braid 52 has high flexural endurance and is capable of withstanding tortuous manipulation with use. In an exemplary embodiment, each of the conductive strands engages the inner shield 50 at multiple points of contact along the length of the cable 14 to electrically connect the outer shield 52 to the inner shield 50 at such multiple points of contact. The outer shield 52 provides electrical continuity along the length of the cable 14. The outer shield 52 may be another type of shield in alternative embodiments, such as, but not limited to, a laminated metal tape, a metal laminated polyimide tape, a metal laminated biaxially-oriented polyethylene terephthalate (BoPEt) tape, a tube formed from a continuous (e.g., a sheet) conductive material, and/or the like.

The inner and outer shields 50, 52 define a double shield structure for the twisted pair 26 of insulated conductors 28. The double shield structure maintains electrical integrity of the shield structure during use. In an exemplary embodiment, the inner shield 50 has a different structure than the outer shield 52. For example, the inner shield 50 is a metal film designed or selected to have high quality electrical shielding characteristics, while the outer shield 52 is a conductive braid designed or selected to have high flexibility and durability characteristics. As is typical of metal films, the metal film may break, crack, tear, or otherwise separate into different pieces or segments 60 over time, such as during manipulation or bending of the cable 14. The shield segments 60 may be separated by breaks 62 or spaces between the segments 60. With conventional designs, such segmenting of the shield detrimentally affects the electrical shielding ability of such shield. However, with the cable 14, the outer shield 52 is electrically coupled to the inner shield 50 along the length of the cable 14. The outer shield 52 bridges the segments 60, thus electrically commoning the segments 60. The outer shield 52 is able to withstand the tortuous manipulation and bending of the cable 14 without damage to the outer shield 52 part of the shield structure. The outer shield 52 electrically connects each of the shield segments 60 of the inner shield 50 (e.g. after the inner shield 50 breaks apart from manipulation) to provide electrical continuity of the shield segments 60 along the length of the cable 14. Additionally, as is typical of braid shields, the electrical shielding and coverage is less effective than with films or tapes. However, because the cable 14 includes the inner shield 50, the electrical shielding is greatly improved as compared to conventional cables that only include a braid shield. The double shield structure provides the dual benefit of high quality electrical shielding and cable flexibility.

The cable jacket 54 surrounds the outer shield 52, inner shield 50 and the conductors 28. The cable jacket 54 seals the conductors 28 and shields 50, 52 from the environment within the cable bundle 10 (shown in FIG. 1). The cable jacket 54 is fabricated from any insulative, non-conductive material, such as, but not limited to, a polymer such as PVC, polypropylene, a fluoropolymer, polyethylene, and/or the like. In an exemplary embodiment, the cable jacket 54 is fabricated from a hydrophobic material defining a moisture barrier for the corresponding inner shield 50, outer shield 52 and twisted pair 26 of insulated conductors 28. The cable jacket 54 provides durability to support sterilization processes of the cable 14. For example, the cable jacket 54 prevents moisture from the sterilization process from contacting the inner shield 50, outer shield 52 and twisted pair 26 of insulated conductors 28, thus maintaining the mechanical and electrical integrity of the inner shield 50, outer shield 52 and twisted pair 26 of insulated conductors 28. Even if moisture permeates the central core 16 of the cable bundle 10 (both shown in FIG. 1), such moisture will be unable to permeate the inner shield 50, outer shield 52 or insulated conductors 28 because of the moisture barrier defined by the cable jacket 54. The cable jacket 54 may be fabricated from a material that is resistant to one or more particular chemicals, such as chemicals used in sterilization processes. The cable jacket 54 may provide high temperature resistance, such as for use in high temperature sterilization. The cable jacket 54 provides an extra level of protection for the inner shield 50, outer shield 52 and twisted pair 26 of insulated conductors 28 in addition to the bundle jacket 12 (shown in FIG. 1). The cable jacket 54 may provide a dielectric material in the vicinity of the twisted pair 26 of insulated conductors 28 to maintain the electrical dielectric constant in the air gap between two cables 14.

With reference back to FIG. 1, embodiments described herein provide a high speed cable bundle 10 adapted for use in harsh environments. The cable bundle 10 includes a plurality of cables 14, each providing dedicated shielding for the conductors of such cable 14 as well as dedicated protection of such shielding to maintain mechanical and electrical performance of such shielding and cable for prolonged use. The cable bundle 10 may be particularly adapted for use in applications that require sterilization compatibility as each of the cables 14 includes a cable jacket 54 that surrounds the corresponding shield structure of the cable 14. Such cable jacket 54 is independent of and used in addition to the bundle jacket 12 that surrounds the entire cable bundle 10.

One particular application the cable bundle 10 may be suited for is camera based medical endoscopes used for internal imaging of the patient's body during surgical procedures. Such endoscopes have need for high speed cables 14 capable of sending high speed signals, such as at speeds of 5 gigabits per second or more. The system demands consistency and reliability of the images during use and over repeated uses for patient safety. Such cables 14 are subjected to manipulation and bending during use at a much greater frequency as compared to typical data communication cables that are laid in an office environment and rarely, if ever, moved once laid. The cables 14 are capable of maintaining mechanical and electrical integrity even with the manipulation and bending of the cable bundle 10 with the use of the dedicated double shield structure for the twisted pair 26 of conductors 28. The double shield structure includes an inner shield 50 (e.g. a metal foil or tape) having good electrical shielding characteristics and an outer shield 52 (e.g. a conductive braid) having good flexibility characteristics that maintains electrical continuity along the length of the cable 14 by electrically connecting all segmented or separated shield portions.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A cable bundle comprising:
a bundle jacket having a central core; and
a plurality of cables received in the central core and surrounded by the bundle jacket, each cable comprising a twisted pair of insulated conductors, a dedicated inner shield surrounding the corresponding twisted pair of insulated conductors, a dedicated outer braid surrounding the corresponding inner shield and being electrically coupled to the corresponding inner shield, and a dedicated jacket surrounding the corresponding outer braid.

2. The cable bundle of claim 1, wherein the inner shield and outer braid cooperate to provide a continuous shield along the entire length of the cable.

3. The cable bundle of claim 1, wherein the inner shield is segmented into a plurality of shield segments, the outer braid electrically connecting the shield segments along the length of the cable.

4. The cable bundle of claim 3, wherein the outer braid comprises a plurality of conductive strands, each strand being electrically connected to at least two shield segments of the inner shield.

5. The cable bundle of claim 1, wherein the inner shield is manufactured from a material having better electrical shielding characteristic than the outer braid and wherein the outer braid is manufactured from a material having better flexibility characteristics than the inner shield.

6. The cable bundle of claim 1, wherein the inner shield is a film having an insulating layer and a metal layer, the metal layer facing the outer braid and the outer braid being electrically connected to the metal layer.

7. The cable bundle of claim 6, wherein the film is a polyester film.

8. The cable bundle of claim 6, wherein the metal layer is a copper layer.

9. The cable bundle of claim 1, wherein the cable jacket provides a moisture barrier for the corresponding outer braid, inner shield and twisted pair of insulated conductors.

10. The cable bundle of claim 1, wherein the cable jacket is a fluorocarbon material.

11. The cable bundle of claim 1, wherein the outer braid of each cable within the central core is separated from other outer braids by the cable jackets of the corresponding cables.

12. A cable bundle comprising:
a bundle jacket having a central core; and
a plurality of cables received in the central core and surrounded by the bundle jacket, each cable comprising a twisted pair of insulated conductors, a dedicated inner shield, a dedicated outer shield, and a dedicated cable jacket, the inner shield comprising a film having an insulating layer and a metal layer, the inner shield surrounding the corresponding twisted pair of insulated conductors with the metal layer facing away from the twisted pair of insulated conductors, the outer shield comprising a conductive braid surrounding the corresponding inner shield and being electrically coupled to the corresponding inner shield at a plurality of locations along a length of the conductive braid, the cable jacket surrounding the corresponding outer braid, the cable jacket comprising a hydrophobic material defining a moisture barrier for the corresponding outer shield, inner shield and twisted pair of insulated conductors.

13. The cable bundle of claim 12, wherein the inner shield and outer braid cooperate to provide a continuous shield along the entire length of the cable.

14. The cable bundle of claim 12, wherein the inner shield is segmented into a plurality of shield segments, the outer shield electrically connecting the shield segments along the length of the cable.

15. The cable bundle of claim 14, wherein the outer shield comprises a plurality of conductive strands, each strand being electrically connected to at least two shield segments of the inner shield.

16. The cable bundle of claim 12, wherein the cable jacket is a fluorocarbon material.

17. A cable bundle comprising:
a bundle jacket having a central core;
a bundle shield in the central core, the bundle shield being metal and defining an electrical shield for the central core;
a drain wire in the central core and being electrically connected to the bundle shield; and
a plurality of cables received in the central core and surrounded by the bundle jacket, each cable comprising a twisted pair of insulated conductors, a dedicated inner shield surrounding the corresponding twisted pair of insulated conductors, a dedicated outer braid surrounding the corresponding inner shield and being electrically coupled to the corresponding inner shield, and a dedicated jacket surrounding the corresponding outer braid.

18. The cable bundle of claim 17, wherein the inner shield and outer braid cooperate to provide a continuous shield along the entire length of the cable.

19. The cable bundle of claim 17, wherein the inner shield is segmented into a plurality of shield segments, the outer braid electrically connecting the shield segments along the length of the cable.

20. The cable bundle of claim 17, wherein the inner shield is a film having an insulating layer and a metal layer, the metal layer facing the outer braid and the outer braid being electrically connected to the metal layer.
